(19) United States
(12) Patent Application Publication
(10) Pub. No.: US 2019/0201841 A1
(43) Pub. Date: Jul. 4, 2019

(54) Integrated Wet Scrubbing System

(71) Applicant: Pacific Green Technologies Inc., San Jose, CA (US)

(72) Inventor: Kenneth James MCCLELLAND, West Vancouver (CA)

(21) Appl. No.: 16/325,346

(22) PCT Filed: Aug. 31, 2016
(86) PCT No.: PCT/CA2016/000223

§ 371 Date: Feb. 13, 2019

Related U.S. Application Data
(60) Provisional application No. 62/376,619, filed on Aug. 18, 2016.

(51) Int. Cl. B01D 53/75; B01D 51/10; B01D 53/50; B01D 53/64; B01D 53/68; B01D 53/70; B01D 53/78; B01D 53/80; B01D 53/82; B01D 47/06; B01D 53/44; B01D 21/26; B01D 36/04; B03C 3/017; B03C 3/16

(52) U.S. Cl. CPC B01D 53/75; B01D 2258/0291; B01D 53/501; B01D 53/64; B01D 53/685; B01D 53/70; B01D 53/78; B01D 53/80; B01D 53/82; B01D 47/06; B01D 53/44; B01D 21/267; B01D 21/262; B01D 36/045; B03C 3/017; B03C 3/16; B01D 53/68; B01D 2251/404; B01D 2251/604; B01D 2251/606; B01D 2257/2045; B01D 2257/2047; B01D 2257/206; B01D 2257/602; B01D 2257/302; B01D 2257/708; B01D 2253/102; B01D 2258/012; B01D 2258/0283; B01D 51/10

(57) ABSTRACT

The present invention relates to an advanced system for the removal of air pollutants from combustion and non-combustion processes that generate air pollutants that are regulated by environmental agencies. The pollutants include, but are not limited to, particulate matter; acid gases including sulphur dioxide, hydrogen chloride and hydrogen fluoride; metals such as mercury, dioxins, VOCs and reagents such as ammonia. The system collects and processes the polluted gas stream through two forms of wet method scrubbing technology. The gas is first passed through a wet scrubbing reactor capable of complete interaction between the gas and the selected liquid scrubbing reagent at one or more interfaces. The scrubbing medium is selected for its reactivity with the pollutants targeted in the process, its cost and impact on the environment. From the exit of the scrubbing reactor the gas is directed through a wet electrostatic precipitator to remove the remaining targeted pollutants to very high removal efficiency.

### FIELD OF THE INVENTION

The invention relates to air quality equipment. In particular, the invention relates to removal of air emissions from industrial processes.

### BACKGROUND OF INVENTION

As more is learned about the detrimental impact on human health, the environment and global warming as a result of emissions from combustion, chemical and industrial processes, environmental agencies are creating and enforcing increasingly restrictive regulations governing the emission levels permitted for air pollutants. In order to not only meet today's but also future regulatory standards enhanced technologies are required to provide global industry with air emission control systems. In addition, these technologies must be energy efficient and effectively use consumables in order to minimize operating costs and impact on the environment.

The emissions resulting from the combustion of coal, municipal solid waste and biomass have been increasingly restricted by Environmental Agencies as a result of greater public demand for environmental protection coupled with advancements in pollution abatement technologies which allow more restrictive standards to be implemented. The restrictions vary by nation, region and proximity of the combustion source to population centers. The regulations target a wide range of combustion by-products including particulate matter; acid gases such as sulphur dioxide, hydrogen chloride and hydrogen fluoride; metals in groups known for their detriment to health such as mercury and greenhouse gases where carbon dioxide and oxides of nitrogen are foremost on the list. Many of the devices in use today by utilities and industrial processes to abate pollutants have a history of development dating from the establishment of the first environmental regulations. These devices employ known chemical and mechanical processes to remove the regulated pollution components from flue gases to accepted levels. In addition, new technologies have been introduced using alternative methods to achieve the required emission concentrations. The emission limits in force today and those pending implementation require systems to have a more focused approach in order to meet the standards. The approach requires the optimization of each step of the abatement process by refining existing technologies, introducing more effective approaches and combining systems to achieve substantial increases in removal efficiencies.

Emission technologies for the combustion technologies noted above can be broadly broken into wet and dry systems. Dry systems utilize different technologies to address the removal of acid gases and particulate. Dry flue gas desulphurization is commonly accomplished by the controlled spraying of aqueous based lime slurry into the gas stream as it rises in a spray dryer tower. The lime based solution reacts with the sulphur and the process is controlled such that the aqueous component of the slurry fully evaporates leaving a dry solid which can be extracted from the bottom of the tower or removed by the selected particulate removal technology. Common among the dry particulate systems are bag filters and electrostatic precipitators.

Wet systems use in conjunction with combustion flue gases commonly use aqueous based slurry comprised of an alkaline material such as limestone, lime, hydrated lime and or enhanced lime. Basic wet systems utilize sprayers to distribute the slurry to react with the flue gas to remove oxides of sulphur, chlorine and fluorine through the formation of solid calcium based salts such as calcium sulphites and sulphates, calcium chloride and calcium fluoride which are produced by the reaction with the alkaline reagent as it rises in a spray tower or similar device.

### BRIEF DESCRIPTION OF DRAWINGS

A detailed description of the preferred embodiments is provided below by way of example only and with reference to the following drawings, in which:

FIG. 1 is a schematic layout of the system representing the present invention;

FIG. 2 is a schematic layout of another embodiment of the system represented by the present invention;

FIG. 3 is a schematic layout of another embodiment of the system represented by the present invention;

FIG. 4 is a schematic layout of another embodiment of the system represented by the present invention;

FIG. 5 is a schematic layout of another embodiment of the system representing the present invention.

In the drawings, each embodiment of the invention is illustrated by way of example. It is to be expressly understood that the description and drawings are only for the purpose of illustration and as an aid to understanding, and are not intended as a definition of the limits of the invention.

### DETAILED DESCRIPTION OF THE INVENTION

Alternative wet scrubbing systems employ design approaches which force the interaction of the flue gas with the alkaline reagent, commonly one or more of limestone, lime, hydrated lime or enhanced lime. By forcing the flue gas/slurry interaction these systems create a turbulent reaction zone that increases reaction time, ensures complete interaction between the flue gas and alkaline slurry which improves acid gas removal efficiency. In addition, the turbulent zone creates an environment for the transfer of particulate matter from the flue gas to the scrubbing solution. Thus, some forms of wet systems have the capacity of removing multiple pollutants in a single pass.

Improved gas scrubbers have multiple interaction levels, each with a turbulent reaction zone that further processes 100% of the flue gas. Each of the reaction zones is capable of using a different reagent which may be selected to enhance removal effectiveness of targeted pollutants or address the removal of additional pollutants in a single pass system.

The emissions resulting from the combustion of diesel fuels in marine and power generation are also sources of regulated emissions. General cargo and container ships that carry the goods of international trade burn bunker grade fuels that contain up to 4.5% sulphur although typically in the range of 2.5 to 2.7%. In addition, these marine diesel engines produce large amounts of ash, soot and unburned fuel that are emitted to the atmosphere on the world's oceans. The sulphur and particulate content is beyond the environmental regulations for land based operations. Regulations for emissions on land are being set by regional and national environmental agencies and in international waters by the International Marine Organization. The options include adding scrubbing technologies or changing the fuel supply for ships to low sulphur fuels.

Chemical and industrial processes generate pollutants that may be removed by chemical interaction with neutralizing reagents or transfer mechanisms in the case of particulate matter.

The range of acid, odorous and harmful chemical emissions from industrial processes requires scrubbing technologies that can effectively remove multiple contaminants in a single pass. Environmental regulations again impose limits on emissions that govern harmful gases and the emissions of dust from industries in these sectors that include chemical production, pulp and paper and composite wood products panel production.

The more restrictive emission limits being imposed on air pollutants from combustion, industrial and chemical processes require the advancement and integration of technologies in order to provide the abatement systems to meet the future requirements of industry.

One application of the present invention is the removal of particulate matter; acid gases including sulphur dioxide, hydrogen chloride and hydrogen fluoride from combustion and industrial processes. The system is comprised of the following steps:
(1) cool the hot gas and remove a portion of the acid gases by passing the flue gas through a chamber containing spray heads emitting an aqueous based slurry formed by adding an alkaline reagent such as limestone, hydrated lime, lime or enhanced lime to water;
(2) introduce the gas to a wet scrubber using the same aqueous slurry containing an alkaline reagent such as limestone, hydrated lime, lime or enhanced lime as its scrubbing solution to remove the remaining acid gases and a significant amount of particulate matter;
(3) circulate the scrubbing solution through solids separation devices such as a hydrocyclones to remove solids for further processing in dewatering devices and direct the reduced solids component of the circulated flow to the scrubber heads following the addition of neutralizing reagents;
(4) pass the gas stream to a Wet Electrostatic Precipitator for removal of remaining particulate matter;
(5) transfer the flue gas to the stack;
(6) direct the fluid effluent from the cooling device, wet scrubber and wet electrostatic precipitator to a solids settling tank;
(7) transfer the high density settled solids from the settling tank to a solids separation device such as a hydrocyclone;
(8) process the high solids underflow in a dewatering device such as a vacuum belt filter or decanter centrifuge. The solids are sent to landfill and the liquid portion is returned to the settling tank; and
(9) direct the low solids overflow from the solids separation device to the cooling unit following conditioning with a neutralizing reagent.

A further application of the present invention is the removal of particulate matter; acid gases including sulphur dioxide, hydrogen chloride and hydrogen fluoride; dioxins, VOCs and mercury from combustion and industrial processes and reheat if required. The system is comprised of the following steps:
(1) process the contaminated flue gas stream through an initial particulate removal device such as a multicyclone or similar to remove large particulate;
(2) direct the flue gas to a heat exchange device;
(3) cool the hot gas and remove a portion of the acid gases by passing the flue gas through a chamber containing spray heads emitting an aqueous based slurry formed by adding an alkaline reagent such as limestone, hydrated lime, lime or enhanced lime to water;
(4) introduce the gas to a wet scrubber using an aqueous slurry containing an alkaline reagent such as limestone, hydrated lime, lime or enhanced lime as its scrubbing solution to remove the remaining acid gases and a significant amount of particulate matter.
(5) circulate the scrubbing solution through solids separation devices such as hydrocyclones to remove solids for further processing and direct the balance of the fluid to the scrubber heads following the addition of neutralizing reagents;
(6) introduce the gas to a vessel where it interacts with granular activated carbon to remove dioxins, VOCs and metals where the primary target is the removal of mercury;
(7) pass the gas stream to a wet electrostatic precipitator for removal of remaining particulate matter;
(8) transfer the flue gas to the heat exchanger
(9) duct the heated gas from the heat exchanger to the stack.
(10) direct the fluid effluent from the cooling device, wet scrubber and wet electrostatic precipitator to a settling tank.
(11) transfer the high density settled solids from the settling tank to a solids separation device such as a hydrocyclone.
(12) process the high solids underflow in a dewatering device such as a vacuum belt filter or decanter centrifuge. The solids are sent to landfill and the liquid portion is returned to the settling tank.
(13) direct the low solids overflow from the solids separation device to the cooling unit following conditioning with a neutralizing reagent.

The design objective of the present invention includes integrating compatible technologies in a manner that significantly exceeds the regulated limits for targeted air pollutants while remaining cost effective and scalable. The present invention provides a system for removing targeted pollutants including particulate matter, acid gases, and mercury from combustion flue gases and industrial processes by integrating wet scrubbing and wet electrostatic precipitator gas cleaning technologies.

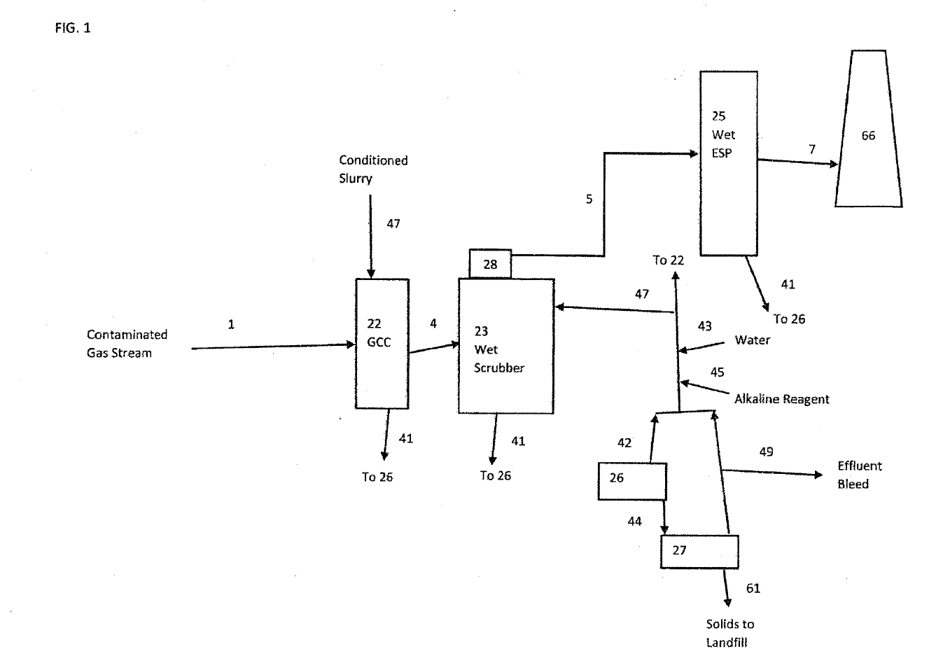

Referring first to FIG. 1, the system is comprised of a gas conditioning chamber (GCC) (22); a wet scrubber (23) and a wet electrostatic precipitator (25). The process in FIG. 1 begins with the gas stream (1) coming from a combustion or industrial process that generates particulate matter, acid gases, and metals that require removal. The gas (1) is directed to the gas conditioning chamber (22) containing spray nozzles or similar emitting an aqueous based slurry (47) formed by adding an alkaline reagent such as limestone, hydrated lime, lime or enhanced lime to water. In the case of hot flue gases the gas conditioning chamber (22) will cool the inlet gas from temperatures in the range of 120° C. to 200° C. to the range of 50° C. to 60° C., with 55° C. being the preferred outlet temperature. The conditioning chamber (22) also acts to remove a portion of the acid gases, typically sulphur dioxide, hydrogen chloride and hydrogen fluoride as a result of the gases reaction with the alkaline slurry (47). In addition, the conditioning chamber serves to wet the particulate matter making it heavier and more reactive in the wet scrubber (23) phase. The conditioning chamber effluent (41) contains products of the reaction and particulate matter. In cases where an aqueous based slurry (47) formed by adding an alkaline reagent such as limestone, hydrated lime, lime or enhanced lime are used, the reaction products are solids that include calcium sulphite, calcium sulphate, calcium chloride and calcium fluoride. These salts are sent to solids separation operations (26) for processing and recirculation. Once conditioned and cooled gas (4) is ducted to a wet scrubber (23) with particulate, acid gas and metals removal capabilities. The functionality of the wet scrubber is suited to the efficient removal of these targeted pollutants. An improved gas scrubber is the preferred embodiment because of its multiple forced head design and its process will be described in the process flow. Each head level of the improved gas scrubber (23) is supplied with an aqueous based slurry (47) formed by adding an alkaline reagent such as limestone, hydrated lime, lime or enhanced lime. Within the wet scrubber (23) the gas (4) is forced upward through a scrubber head containing an array of ports which give the gas a means of passage through the scrubber head. The gas passes through the ports at high velocity into the scrubbing solution (47) which creates a highly turbulent interaction zone above the head. The preferred depth of turbulence is 300 mm to 400 mm. After the gas exits the turbulent zone on the first head it rises in the scrubber and the process is repeated on the second head. The interaction removes acid gases including sulphur dioxide, hydrogen chloride and hydrogen fluoride by forming solid calcium based compounds. The interaction further removes particulate matter from the gas and transfers it to the scrubbing fluid (47). The scrubbing fluid with its entrained salts and particulate is constantly evacuated from the scrubber as an effluent stream (41). The operating temperature of the wet scrubber will mirror the inlet gas (4) temperature of approximately 55° C. The gas (5) is passes through a demisting device (28) as it exits the wet scrubber and is ducted to a wet electrostatic precipitator (25) for removal of the remaining particulate matter with specific focus on sub-micron particles. As the gas passes through the wet electrostatic precipitator (25) it is subjected to a high voltage electrical field while at the same time the device is given an opposing charge. Operating power levels and direction of flow vary with competitive designs. As a result of the electrostatic charge the particulate matter is removed from the gas flow and is retained on the charged wall of the device. A combination of moisture from the wet scrubber and periodic washing of the electrostatic precipitator walls removes the particulate as effluent steam (41). The gas (7) exits the wet electrostatic precipitator and is ducted to the stack. At the time of exit gas (7) is virtually free of the targeted pollutants.

Effluent stream (41) from the gas conditioning chamber, the wet scrubber and the wet electrostatic precipitator are routed to processes capable of separating solids from effluent streams such a hydrocyclone or similar. The high solids underflow (44) is transferred to a dewatering device such as a vacuum belt filter or decanting centrifuge (27). The sludge cake (61) is sent to landfill. The liquid component (46) from the dewatering device (27) and the overflow (42) from the solids separation process is conditioned with alkaline reagent (45) and make up water (43) as required to maintain the solution pH in the preferred range of 6.25 to 6.75. The resulting conditioned slurry (47) is circulated to the wet scrubber and gas conditioning chamber. A portion of the clean over flow (46) from the dewatering process is bled off, typically for use in other processes in the facility. The bleed volume and the evaporation losses in the cooling process are made up with the addition of water (43) as part of the slurry conditioning process.

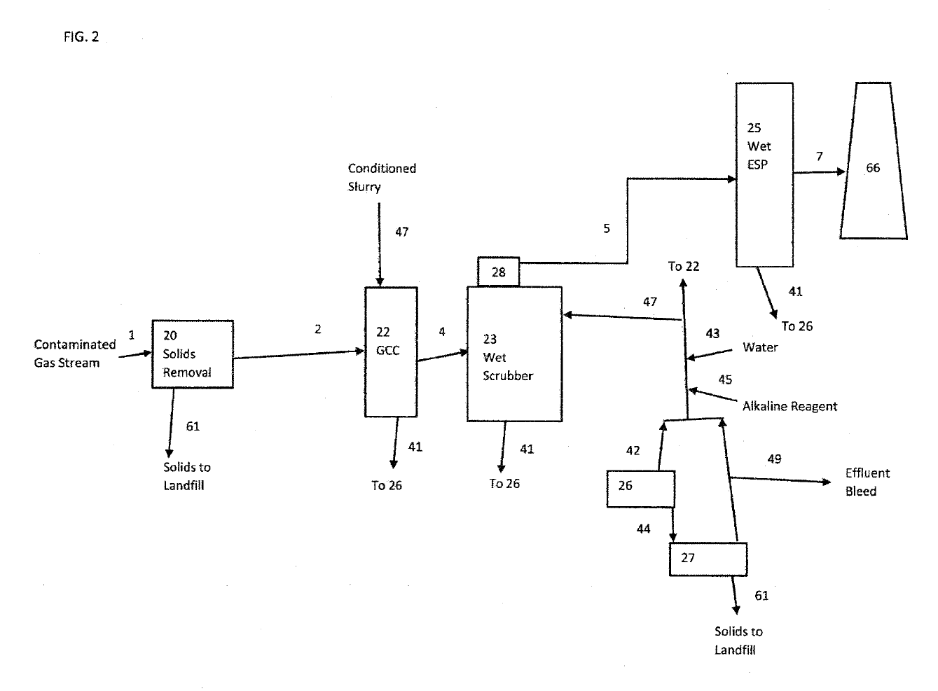

Referring to FIG. 2, the system configuration includes the following components: solids removal device (20); gas conditioning chamber (22); wet scrubber (23); and a wet electrostatic precipitator (25). The process in FIG. 2 begins with the gas stream (1) coming from a combustion or industrial process that generates particulate matter, acid gases, and metals that require removal. In this iteration of the present invention the gas (1) is directed to a solids removal device (20) such as a multicyclone to remove a base amount of large particulate. The particulate matter (61) is collected in the device and transferred to landfill. Upon exiting the solids removal device (20) the gas (2) is directed to the gas conditioning chamber (22) containing spray nozzles or similar emitting an aqueous based slurry (47) formed by adding an alkaline reagent such as limestone, hydrated lime, lime or enhanced lime to water. In the case of hot flue gases the gas conditioning chamber (22) will cool the inlet gas from temperatures in the range of 120° C. to 200° C. to the range of 50° C. to 60° C., with 55° C. being the preferred outlet temperature. The conditioning chamber (22) also acts to remove a portion of the acid gases, typically sulphur dioxide, hydrogen chloride and hydrogen fluoride as a result of the gases reaction with the alkaline slurry (47). In addition, the conditioning chamber serves to wet the particulate matter making it heavier and more reactive in the wet scrubber (23) phase. The conditioning chamber effluent (41) contains products of the reaction and particulate matter. In cases where an aqueous based slurry (47) formed by adding an alkaline reagent such as limestone, hydrated lime, lime or enhanced lime are used, the reaction products are solids that include calcium sulphite, calcium sulphate, calcium chloride and calcium fluoride. These salts are sent to solids separation operations (26) for processing and recirculation. Once conditioned and cooled gas (4) is ducted to a wet scrubber (23) with particulate, acid gas and metals removal capabilities. The functionality of the wet scrubber is suited to the efficient removal of these targeted pollutants. An improved gas scrubber is the preferred embodiment because of its multiple forced head design and its process will be described in the process flow. Each head level of the improved gas scrubber (23) is supplied with an aqueous based slurry (47) formed by adding an alkaline reagent such as limestone, hydrated lime, lime or enhanced lime. Within the wet scrubber (23) the gas (4) is forced upward through a scrubber head containing an array of ports which give the gas a means of passage through the scrubber head. The gas passes through the ports at high velocity into the scrubbing solution (47) which creates a highly turbulent interaction zone above the head. The preferred depth of turbulence is 300 mm to 400 mm. After the gas exits the turbulent zone on the first head it rises in the scrubber and the process is repeated on the second head. The interaction removes acid gases including sulphur dioxide, hydrogen chloride and hydrogen fluoride by forming solid calcium based compounds. The interaction further removes particulate matter from the gas and transfers it to the scrubbing fluid (47). The scrubbing fluid with its entrained salts and particulate is constantly evacuated from the scrubber as an effluent stream (41). The operating temperature of the wet scrubber will mirror the inlet gas (4) temperature of approximately 55° C. The gas (5) is passes through a demisting device (28) as it exits the wet scrubber and is ducted to a wet electrostatic precipitator (25) for removal of the remaining particulate matter with specific focus on sub-micron particles. As the gas passes through the wet electrostatic precipitator (25) it is subjected to a high voltage electrical field while at the same time the device is given an opposing charge. Operating power levels and direction of flow vary with competitive designs. As a result of the electrostatic charge the particulate matter is removed from the gas flow and is retained on the charged wall of the device. A combination of moisture from the wet scrubber and periodic washing of the electrostatic precipitator walls removes the particulate as effluent steam (41). The gas (7) exits the wet electrostatic precipitator and is ducted to the stack. At the time of exit gas (7) is virtually free of the targeted pollutants.

Effluent stream (41) from the gas conditioning chamber, the wet scrubber and the wet electrostatic precipitator are routed to processes capable of separating solids from effluent streams such a hydrocyclone or similar. The high solids underflow (44) is transferred to a dewatering device such as a vacuum belt filter or decanting centrifuge (27). The sludge cake (61) is sent to landfill. The liquid component (46) from the so dewatering device (27) and the overflow ((42) from the solids separation process is conditioned with alkaline reagent (45) and make up water (43) as required to maintain the solution pH in the preferred range of 6.25 to 6.75. The resulting conditioned slurry (47) is circulated to the wet scrubber and gas conditioning chamber. A portion of the clean over flow (46) from the dewatering process is bled off, typically for use in other processes in the facility. The bleed volume and the evaporation losses in the cooling process are made up with the addition of water (43) as part of the slurry conditioning process.

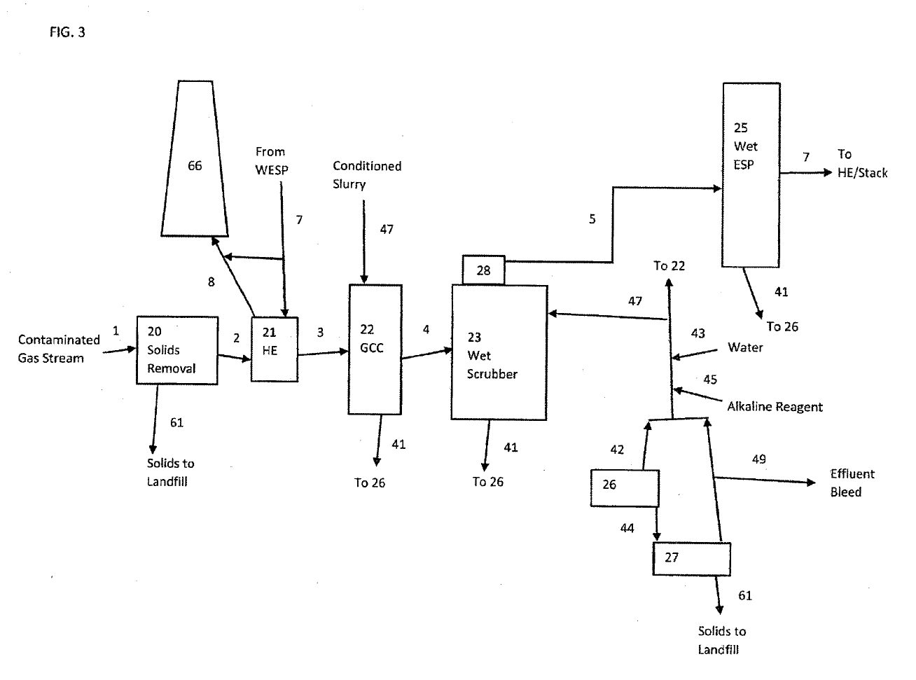

Referring to FIG. 3, the system configuration includes the following components: solids removal device (20); heat exchanger (21); gas conditioning chamber (22); wet scrubber (23); and a wet electrostatic precipitator (25). The process in FIG. 3 begins with the gas stream (1) coming from a combustion or industrial process that generates particulate matter, acid gases and metals that require removal. FIG. 3 also illustrates a flue gas (7) reheating option for applications where the visibility of the stack plume is to be minimized. In this iteration of the present invention the gas (1) is directed to a solids removal device (20) such as a multicyclone to remove a base amount of large particulate. The particulate matter (61) is collected in the device and transferred to landfill. The exiting gas (2) is ducted to a heat exchanger (21) where it cools as it gives up heat to the cooler counter-flowing gas (7). The heat exchanger (21) type and materials are selected for operating environment and heat transfer requirements. The gas (3) exits the heat exchanger and is carried to the gas conditioning chamber (22) containing spray nozzles or similar emitting an aqueous based slurry (47) formed by adding an alkaline reagent such as limestone, hydrated lime, lime or enhanced lime to water. In the case of hot flue gases the gas conditioning chamber (22) will cool the inlet gas from temperatures in the range of 120° C. to 200° C. to the range of 50° C. to 60° C. with 55° C. being the preferred outlet temperature. The conditioning chamber (22) also acts to remove a portion of the acid gases, typically sulphur dioxide, hydrogen chloride and hydrogen fluoride as a result of the gases reaction with the alkaline slurry (47). In addition, the conditioning chamber serves to wet the particulate matter making it heavier and more reactive in the wet scrubber (23) phase. The conditioning chamber effluent (41) contains products of the reaction and particulate matter. In cases where an aqueous based slurry (47) formed by adding an alkaline reagent such as limestone, hydrated lime, lime or enhanced lime are used, the reaction products are solids that include calcium sulphite, calcium sulphate, calcium chloride and calcium fluoride. These salts are sent to solids separation operations (26) for processing and recirculation. Once conditioned and cooled gas (4) is ducted to a wet scrubber (23) with particulate, acid gas and metals removal capabilities. The functionality of the wet scrubber is suited to the efficient removal of these targeted pollutants. An improved gas scrubber is the preferred embodiment because of its multiple forced head design and its process will be described in the process flow. Each head level of the improved gas scrubber (23) is supplied with an aqueous based slurry (47) formed by adding an alkaline reagent such as limestone, hydrated lime, lime or enhanced lime. Within the wet scrubber (23) the gas (4) is forced upward through a scrubber head containing an array of ports which give the gas a means of passage through the scrubber head. The gas passes through the ports at high velocity into the scrubbing solution (47) which creates a highly turbulent interaction zone above the head. The preferred depth of turbulence is 300 mm to 400 mm. After the gas exits the turbulent zone on the first head it rises in the scrubber and the process is repeated on the second head. The interaction removes acid gases including sulphur dioxide, hydrogen chloride and hydrogen fluoride by forming solid calcium based compounds. The interaction further removes particulate matter from the gas and transfers it to the scrubbing fluid (47). The scrubbing fluid with its entrained salts and particulate is constantly evacuated from the scrubber as an effluent stream (41). The operating temperature of the wet scrubber will mirror the inlet gas (4) temperature of approximately 55° C. The gas (5) is passes through a demisting device (28) as it exits the wet scrubber and is ducted to a wet electrostatic precipitator (25) for removal of the remaining particulate matter with specific focus on sub-micron particles. As the gas passes through the wet electrostatic precipitator (25) it is subjected to a high voltage electrical field while at the same time the device is given an opposing charge. Operating power levels and direction of flow vary with competitive designs. As a result of the electrostatic charge the particulate matter is removed from the gas flow and is retained on the charged wall of the device. A combination of moisture from the wet scrubber and periodic washing of the electrostatic precipitator walls removes the particulate as effluent steam (41). The gas (7) exits the wet electrostatic precipitator and is ducted to the stack. At the time of exit gas (7) is virtually free of the targeted pollutants.

Effluent stream (41) from the gas conditioning chamber, the wet scrubber and the wet electrostatic precipitator are routed to processes capable of separating solids from effluent streams such a hydrocyclone or similar. The high solids underflow (44) is transferred to a dewatering device such as a vacuum belt filter or decanting centrifuge (27). The sludge cake (61) is sent to landfill. The liquid component (46) from the dewatering device (27) and the overflow ((42) from the solids separation process is conditioned with alkaline reagent (45) and make up water (43) as required to maintain the solution pH in the preferred range of 6.25 to 6.75. The resulting conditioned slurry (47) is circulated to the wet scrubber and gas conditioning chamber. A portion of the clean over flow (46) from the dewatering process is bled off, typically for use in other processes in the facility. The bleed volume and the evaporation losses in the cooling process are made up with the addition of water (43) as part of the slurry conditioning process.

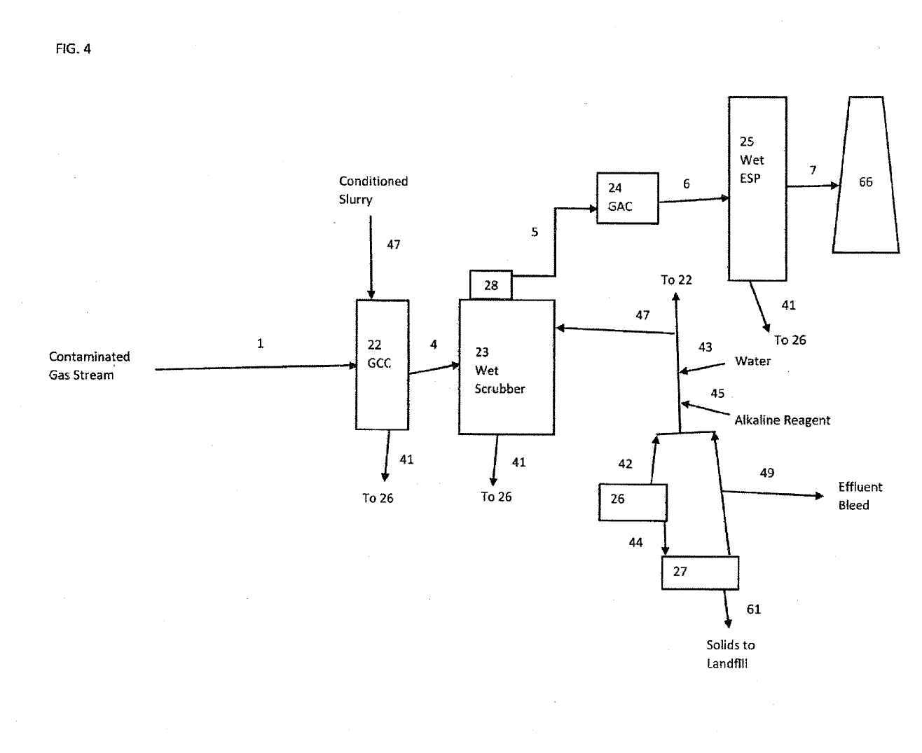

Referring to FIG. 4, the system is comprised of a gas conditioning chamber (GCC) (22); a wet scrubber (23); a granular activated carbon reaction chamber (24) and a wet electrostatic precipitator (25). The process in FIG. 4 begins with the gas stream (1) coming from a combustion or industrial process that generates particulate matter; acid gases including sulphur dioxide, hydrogen chloride and hydrogen fluoride; dioxins, VOCs and metals including mercury require removal. In this iteration of the present invention the gas (1) is directed to the gas conditioning chamber (22) containing spray nozzles or similar emitting an aqueous based slurry (47) formed by adding an alkaline reagent such as limestone, hydrated lime, lime or enhanced lime to water. In the case of hot flue gases the gas conditioning chamber (22) will cool the inlet gas from temperatures in the range of 120° C. to 200° C. to the range of 50° C. to 60° C. with 55° C. being the preferred outlet temperature. The conditioning chamber (22) also acts to remove a portion of the acid gases, typically sulphur dioxide, hydrogen chloride and hydrogen fluoride as a result of the gases reaction with the alkaline slurry (47). In addition, the conditioning chamber serves to wet the particulate matter making it heavier and more reactive in the wet scrubber (23) phase. The conditioning chamber effluent (41) contains products of the reaction and particulate matter. In cases where an aqueous based slurry (47) formed by adding an alkaline reagent such as limestone, hydrated lime, lime or enhanced lime are used, the reaction products are solids that include calcium sulphite, calcium sulphate, calcium chloride and calcium fluoride. These salts are sent to solids separation operations (26) for processing and recirculation. Once conditioned and cooled gas (4) is ducted to a wet scrubber (23) with particulate, acid gas and metals removal capabilities. The functionality of the wet scrubber is suited to the efficient removal of these targeted pollutants. An improved gas scrubber is the preferred embodiment because of its multiple forced head design and its process will be described in the process flow. Each head level of the improved gas scrubber (23) is supplied with an aqueous based slurry (47) formed by adding an alkaline reagent such as limestone, hydrated lime, lime or enhanced lime. Within the wet scrubber (23) the gas (4) is forced upward through a scrubber head containing an array of ports which give the gas a means of passage through the scrubber head. The gas passes through the ports at high velocity into the scrubbing solution (47) which creates a highly turbulent interaction zone above the head. The preferred depth of turbulence is 300 mm to 400 mm. After the gas exits the turbulent zone on the first head it rises in the scrubber and the process is repeated on the second head. The interaction removes acid gases including sulphur dioxide, hydrogen chloride and hydrogen fluoride by forming solid calcium based compounds. The interaction further removes particulate matter from the gas and transfers it to the scrubbing fluid (47). The scrubbing fluid with its entrained salts and particulate is constantly evacuated from the scrubber as an effluent stream (41). The operating temperature of the wet scrubber will mirror the inlet gas (4) temperature of approximately 55° C. The gas (5) is passes through a demisting device (28) as it exits the wet scrubber and is ducted to a reaction vessel (24) containing a bed of granular activated carbon. The granular activated carbon adsorbs dioxins, VOCs and metals of which the foremost target is mercury. The adsorption capacity of granular activated carbon is limited and the material may be regenerated or disposed of in landfill. The gas (6) exits the reaction vessel and is ducted to a wet electrostatic precipitator (25) for removal of the remaining particulate matter with specific focus on sub-micron particles. and is ducted to a wet electrostatic precipitator (25) for removal of the remaining particulate matter with specific focus on sub-micron particles. As the gas passes through the wet electrostatic precipitator (25) it is subjected to a high voltage electrical field while at the same time the device is given an opposing charge. Operating power levels and direction of flow vary with competitive designs. As a result of the electrostatic charge the particulate matter is removed from the gas flow and is retained on the charged wall of the device. A combination of moisture from the wet scrubber and periodic washing of the electrostatic precipitator walls removes the particulate as effluent steam (41). The gas (7) exits the wet electrostatic precipitator and is ducted to the stack. At the time of exit gas (7) is virtually free of the targeted pollutants.

Effluent stream (41) from the gas conditioning chamber, the wet scrubber and the wet electrostatic precipitator are routed to processes capable of separating solids from effluent streams such a hydrocyclone or similar. The high solids underflow (44) is transferred to a dewatering device such as a vacuum belt filter or decanting centrifuge (27). The sludge cake (61) is sent to landfill. The liquid component (46) from the dewatering device (27) and the overflow ((42) from the solids separation process is conditioned with alkaline reagent (45) and make up water (43) as required to maintain the solution pH in the preferred range of 6.25 to 6.75. The resulting conditioned slurry (47) is circulated to the wet scrubber and gas conditioning chamber. A portion of the clean over flow (46) from the dewatering process is bled off, typically for use in other processes in the facility. The bleed volume and the evaporation losses in the cooling process are made up with the addition of water (43) as part of the slurry conditioning process.

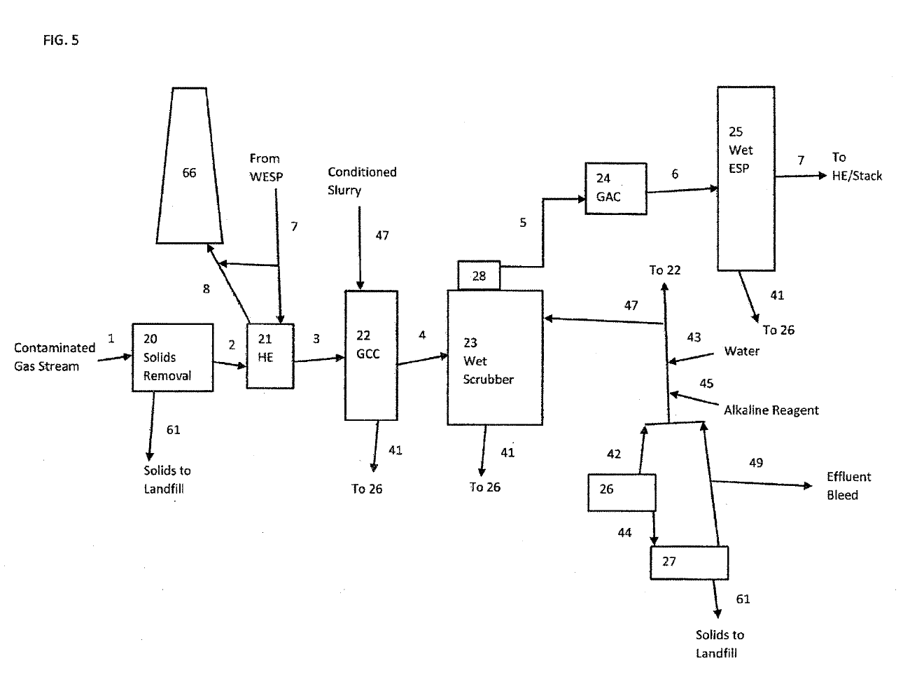

Referring to FIG. 5, the system is comprised of a solids removal device (20); heat exchanger (21); gas conditioning chamber (22); wet scrubber (23); granular activated carbon reaction chamber (24) and a wet electrostatic precipitator (25). The process in FIG. 5 begins with the gas stream (1) coming from a combustion or industrial process that generates particulate matter; acid gases including sulphur dioxide, hydrogen chloride and hydrogen fluoride; dioxins, VOCs and metals including mercury that require removal. In this iteration of the present invention the flue gas (1) is directed to a solids removal device (20) such as a multicyclone to remove a base amount of large particulate. The particulate matter (61) is collected in the device and transferred to landfill. The exiting gas (2) is ducted to a heat exchanger (21) where it cools as it gives up heat to the cooler counter-flowing gas (7). The heat exchanger (21) type and materials are selected for operating environment and heat transfer requirements. The gas (3) exits the heat exchanger and is carried to the gas conditioning chamber (22) containing spray nozzles or similar emitting an aqueous based slurry (47) formed by adding an alkaline reagent such as limestone, hydrated lime, lime or enhanced lime to water. In the case of hot flue gases the gas conditioning chamber (22) will cool the gas from temperatures in the range of 120° C. to 200° C. to the range of 50° C. to 60° C. with 55° C. being the preferred outlet temperature. The conditioning chamber (22) also acts to remove a portion of the acid gases, sulphur dioxide, hydrogen chloride and hydrogen fluoride as a result of the reaction with the alkaline slurry (47). In addition, the conditioning chamber serves to wet the particulate matter making it heavier and more reactive in the wet scrubber (23) phase. The conditioning chamber effluent (41) contains products of the reaction and particulate matter. In cases where an aqueous based slurry (47) formed by adding an alkaline reagent such as limestone, hydrated lime, lime or enhanced lime are used, the reaction products are solids that include calcium sulphite, calcium sulphate, calcium chloride and calcium fluoride. These salts are sent to solids separation operations (26) for processing and recirculation. Once conditioned and cooled gas (4) is ducted to a wet scrubber (23) with particulate, acid gas and metals removal capabilities. The functionality of the wet scrubber is suited to the efficient removal of these targeted pollutants. An improved gas scrubber is the preferred embodiment because of its multiple forced head design and its process will be described in the process flow. Each head level of the improved gas scrubber (23) is supplied with an aqueous based slurry (47) formed by adding an alkaline reagent such as limestone, hydrated lime, lime or enhanced lime. Within the wet scrubber (23) the gas (4) is forced upward through a scrubber head containing an array of ports which give the gas a means of passage through the scrubber head. The gas passes through the ports at high velocity into the scrubbing solution (47) which creates a highly turbulent interaction zone above the head. The preferred depth of turbulence is 300 mm to 400 mm. After the gas exits the turbulent zone on the first head it rises in the scrubber (23) and the process is repeated on the second head. The interaction removes acid gases including sulphur dioxide, hydrogen chloride and hydrogen fluoride by forming solid calcium based compounds. The highly turbulent interaction further removes particulate matter from the gas and transfers it to the scrubbing fluid (47). The scrubbing fluid with its entrained salts and particulate is constantly evacuated from the scrubber as an effluent stream (41). The operating temperature of the wet scrubber will mirror the inlet gas (4) temperature of approximately 55° C. The gas (5) is passes through a demisting device (28) as it exits the wet scrubber and is ducted to a reaction vessel (24) containing a bed of granular activated carbon. The granular activated carbon adsorbs dioxins, VOCs and metals of which the foremost target is mercury. The adsorption capacity of granular activated carbon is limited and the material may be regenerated or disposed of in landfill. The gas (6) exits the reaction vessel and is ducted to a wet electrostatic precipitator (25) for removal of the remaining particulate matter with specific focus on sub-micron particles. As the gas passes through the wet electrostatic precipitator (25) it is subjected to a high voltage electrical field while at the same time the device is given an opposing charge. Operating power levels and direction of flow vary with competitive designs. As a result of the polarity of electrostatic charge the particulate matter is removed from the gas flow and is retained on the charged wall of the device. A combination of moisture from the wet scrubber and periodic washing of the electrostatic precipitator walls removes the particulate as effluent steam (41). The gas (7) exits the wet electrostatic precipitator virtually free of targeted pollutants and is ducted to the stack or further routed to the heat exchanger (21) if reheating is required. In the reheating option, the gas (8) is heated to a level that is appropriate for the stack design and plume visibility requirements.

Effluent stream (41) from the gas conditioning chamber, the wet scrubber and the wet electrostatic precipitator are routed to processes capable of separating solids from effluent streams such a hydrocyclone or similar. The high solids underflow (44) is transferred to a dewatering device such as a vacuum belt filter or decanting centrifuge (27). The sludge cake (61) is sent to landfill. The liquid component (46) from the dewatering device (27) and the overflow ((42) from the solids separation process is conditioned with alkaline reagent (45) and make up water (43) as required to maintain the solution pH in the preferred range of 6.25 to 6.75. The resulting conditioned slurry (47) is circulated to the wet scrubber and gas conditioning chamber. A portion of the clean over flow (46) from the dewatering process is bled off, typically for use in other areas of the process. The bleed volume and the evaporation losses in the cooling process are made up with the addition of water (43) as part of the slurry conditioning process.

An integrated wet scrubbing system as embodied in the present invention offers advantages over singular technologies and prior art designs whereby the arrangement of compatible technologies delivers pollutant removal efficiencies far in excess of the regulated requirements for the targeted pollutants, particulate matter, acid gases, dioxins, VOC's, mercury and other metals. The system remains scalable and because of its efficiencies can be operated to minimize the consumption and cost of consumables while continuing to remove pollutants within the regulated limits.

From the foregoing, it will be seen that this invention is one well adapted to attain all of the ends and objectives herein set forth, together with other advantages which are obvious and which are inherent to the system. It will be understood that certain features and sub-combinations are of utility and may be employed with reference to other features and sub-combinations. This is contemplated by and is within the scope of the claims. Many possible embodiments may be made of the invention without departing from the scope of the claims. It is to be understood that all matter herein set forth are shown in the accompanying drawings is to be interpreted as illustrative and not in a limiting sense. It will be appreciated by those skilled in the art that other variations of the preferred embodiment may also be practiced without departing from the scope of the invention.

1. A method for removing contaminants from a hot flue gas stream, comprising the steps of:
a. passing the flue gas stream through a gas conditioning chamber;
b. passing the flue gas stream exiting the gas conditioning chamber to a wet scrubber having a scrubbing slurry;
c, circulating the scrubbing solution through a solids separation device to remove solids for further processing;
d. passing the flue gas stream exiting the wet scrubber to a wet electrostatic precipitator for removal of remaining particulate matter;
e. transferring the flue gas stream exiting the wet electrostatic precipitator to the stack;
f. directing the fluid effluent from the cooling device, the wet scrubber and the wet electrostatic precipitator to a solids settling tank to separate the high density solids from the solids underflow;
g. transferring the high density solids from the settling tank to a solids separation device;
h. passing the high solids underflow exiting the solids separation device to a dewatering device;
i. disposing of the solids exiting the dewatering device to a landfill;
j. conditioning the liquids exiting the dewatering device with a neutralizing reagent; and
k. returning the neutralized liquids to the solids settling tank.

2. The method of claim 1, wherein the gas conditioning chamber contains spray heads which emit a slurry formed by adding an alkaline reagent selected from the group of alkaline reagents comprising limestone, hydrated lime, lime or enhanced lime to water.

3. The method of claim 1, wherein the wet scrubber scrubbing slurry is formed by adding an alkaline reagent selected from the group of alkaline reagents comprising limestone, hydrated lime, lime or enhanced lime to water.

4. The method of claim 1, wherein the solids separation device is a hydrocyclone.

5. The method of claim 1, wherein the dewatering device is selected from the group of dewatering devices comprising a vacuum belt filter and a decanter centrifuge.

6. The method of claim 1, further comprising the additional step (at) before step (a) of passing the flue gas stream through a solids removal device.

7. The method of claim 6, wherein the solids removal device is a multicyclone.

8. The method of claim 6, further comprising the additional step (a₂) after step (a₁) of passing the flue gas stream exiting the solids removal device through a heat exchanger.

9. The method of claim 1, further comprising the additional step (c₁) after step (c) of passing the flue gas stream exiting the wet scrubber through a granular activated carbon reaction chamber.

10. The method of claim 8, further comprising the additional step (c₁) after step (c) of passing the flue gas stream exiting the wet scrubber through a granular activated carbon reaction chamber.

11. A system for removing contaminants from a hot flue gas stream, comprising:
a. a gas conditioning chamber;
b. a wet scrubber having a scrubbing slurry;
c. a solids separation device;
d. a wet electrostatic precipitator;
e. an exhaust stack;
f. a solids settling tank; and
g. a dewatering device.

12. The system of claim 11, further comprising a solids removal device.

13. The system of claim 12, further comprising a heat exchanger.

14. The system of claim 11, further comprising a granular activated carbon reaction chamber.

15. The system of claim 13, further comprising a granular activated carbon reaction chamber.

16. Use of the system of claim 11 for removing from a flue gas stream one or more contaminants selected from the group of contaminants comprising particulates, sulphur dioxide, hydrogen chloride, and hydrogen fluoride.

17. Use of the system of claim 12 for removing from a flue gas stream one or more contaminants selected from the group of contaminants comprising particulates, sulphur dioxide, hydrogen chloride, and hydrogen fluoride.

18. Use of the system of claim 13 for removing from a flue gas stream one or more contaminants selected from the group of contaminants comprising particulates, sulphur dioxide, hydrogen chloride, and hydrogen fluoride.

19. Use of the system of claim 14 for removing from a flue gas stream one or more contaminants selected from the group of contaminants comprising particulates, sulphur dioxide, hydrogen chloride, hydrogen fluoride, dioxins, volatile organic compounds, and mercury.

20. Use of the system of claim 15 for removing from a flue gas stream one or more contaminants selected from the group of contaminants comprising particulates, sulphur dioxide, hydrogen chloride, hydrogen fluoride, dioxins, volatile organic compounds, and mercury.
